(19) United States
(12) Patent Application Publication
(10) Pub. No.: US 2017/0028667 A1
(43) Pub. Date: Feb. 2, 2017

(54) METHOD FOR SHAPING A FLAT WEB MATERIAL, AND DEVICE

(71) Applicant: FOLDCORE GMBH, Notzingen (DE)

(72) Inventors: Martin Fach, Krebberg (DE); Rainer Kehrle, Uberlingen (DE)

(73) Assignee: FOLDCORE GMBH, Notzingen (DE)

(21) Appl. No.: 15/301,065

(22) PCT Filed: Jan. 14, 2015
(86) PCT No.: PCT/EP2015/050574

§ 371 Date: Sep. 30, 2016

(30) Foreign Application Priority Data
Mar. 31, 2014 (DE) 10 2014 206 083.4

(51) Int. Cl. B31F 1/30

(52) U.S. Cl. CPC B31F 1/305

(57) ABSTRACT

The aim of the invention is to shape a flat web material (12) into a constant three-dimensional structure with a plurality of folds along differently oriented folding lines and with elevations and depressions. This is achieved in that the flat web material is inserted between a lower holding die (20b) and an upper holding die (20a), which are largely flat, consist of a flat material, and have pre-shaped bending lines that lie over one another in a precise manner when lying against the flat web material. A lower (30b) and an upper molding die (30a) are then guided thereto and brought into position, said molding dies consisting of a flat material with specified folding lines which oppose one another in a precise manner. The molding dies (30a, 30b) have a shape corresponding to the three-dimensional structure to be produced, and the molding die folding lines oriented towards the holding dies or pointing towards the holding dies match the bending lines of the holding dies, wherein the folding lines can lie against the holding dies.

### AREA OF APPLICATION AND PRIOR ART

The invention relates to a method for shaping a flat web material and to a device suitable for carrying out said method. The shaped flat web material is intended to give a three-dimensional structure of the kind which can be used to advantage in composite construction, especially as a core material between two stable layers.

US 2007/004576 A1 discloses a method by means of which structures of this kind can be produced. In this case, flat web material is deformed by a plurality of shaping rolls, which become increasingly wider in the throughput direction for progressive deformation. Thus, continuously increasing deformation is achieved.

Possible shapes of such a deformed flat web material as a regular three-dimensional structure are known from U.S. Pat. No. 3,698,879. Here, an incoming flat web material is deformed by a multiplicity of shaping jaws, which are actuated in succession and have an increasingly pronounced profile.

### OBJECT AND SOLUTION

It is the underlying object of the invention to provide a method mentioned at the outset and a corresponding device by means of which problems of the prior art can be solved and by means of which, in particular, it is possible to shape a flat web material well and in a practical manner.

This object is achieved by a method having the features of claim 1 and by a device having the features of claim 11. Advantageous and preferred developments of the invention form the subject matter of the other claims and are explained in greater detail below. In this case, some of the features are described only in relation to the method or only in relation to the device. Irrespective of this, however, the intention is that they should apply independently both to the method and to the device. The claims are worded with explicit reference to the contents of the description.

It is envisaged that a flat web material is largely flat or smooth and level in the initial state. It can also be finely corrugated, in a manner similar to a fine corrugated board or the like. At the same time, it can also be preembossed along the subsequent folding edges or preprocessed in a similar way, e.g. having appropriate weakening of the material by perforations or the like, and it can likewise be grooved. In the final state, the material, as it were as the end product of the method, is folded in a regular three-dimensional structure. A multiplicity of folds is provided along differently oriented folding lines, wherein the folding lines preferably run in a small number of directions, e.g. in from two to at most five directions. As an alternative, it can have a corrugated fold geometry, i.e. being corrugated in plan view instead of having straight folding lines. It is thus possible to achieve a complex but clear structure.

To shape the flat web material, it is inserted between a lower holding die and an upper holding die or these are placed against it. These two holding dies are composed of flat material, i.e. originally flat material, and have kink lines, wherein these kink lines are identical on the two holding dies and lie substantially precisely one above the other when they are resting on the flat web material or enclose the latter between them. The holding dies are advantageously composed of the same material, which is, however, advantageously significantly stiffer than the flat web material to be shaped. Along the kink lines, the flat material of the holding dies can be kinked or deformed very frequently and, as will be explained below, can shape the flat web material at the same time. In certain circumstances, the kink lines can also be formed by hinges. The lower and/or upper holding die can be moved up or brought together with the flat web material in succession but are advantageously moved up or brought together therewith simultaneously.

In a further step or subsequently, a lower shaping die and an upper shaping die are moved up to the holding dies from below and from above respectively. This can likewise take place in succession or, advantageously, simultaneously. The shaping dies are also composed of a flat material with predetermined bending lines. They can advantageously be composed of a similar material to or from the same material as the abovementioned holding dies and can often be deformed in the manner of hinges along the bending lines. However, it is particularly advantageous if the material is significantly stiffer, preferably by virtue of increased material thickness, being two to five times as thick for example.

The holding dies are largely or completely level when they are moved up to the flat web material or enclose it between them. It is advantageous if they also still level when the shaping dies are moved up to the holding dies in a further step. In this case, the shaping dies can be moved up in succession but it is advantageous if they are moved up simultaneously.

The lower and the upper shaping die have bending lines which correspond precisely to one another or lie precisely opposite one another. Moreover, the shaping dies are not flat as they are moved up to the holding die but ar raised by bending along the bending lines or have a shape which corresponds to or is at least similar to the three-dimensional structure to be produced with the flat web material. At least some of the bending lines of the shaping dies coincide with some of the kink lines of the holding dies. It is advantageous if these are those bending lines of the shaping dies which are oriented toward or point toward the holding dies and can come to rest thereon.

Moving the shaping dies up to the holding dies or to the compound structure comprising the two holding dies with the flat web material to be deformed, in which compound structure the elements are close together one on top of the other, has the advantage that the folds on the flat web material with the folding lines can be made precisely and in a defined manner by means of the holding dies with the predetermined kink lines resting on the flat web material. Moreover, the shaping dies can rub along the holding dies during the deformation of the latter, wherein the material of the holding dies and of the shaping dies can be chosen so that the surfaces are very smooth and the materials are dimensionally stable with a certain stiffness, especially the shaping die. In this way, a kind of defined and protected shaping of the flat web material can take place between the holding dies, this being initiated and driven by the shaping dies. It is advantageous to provide for the shaping dies to retain their shape, namely that of a raised three-dimensional structure similar to the product to be produced with the flat web material, as the method or shaping of the flat web material progresses. In this case, the holding dies with the flat web material between them can gradually be brought to an increasing extent to the shape of the shaping dies, as can therefore also the flat web material to be shaped, during the pass.

As a further development of the invention, it can be envisaged that, as the shaping dies are moved up to the holding dies, a plane situated in the center between the shaping dies, i.e. a throughput plane, is not yet touched by the shaping dies, not even by those at the points or in the regions furthest away. As the shaping process progresses, the shaping dies are moved ever further toward one another, wherein elevations of the shaping dies along bending lines of one shaping die engage in depressions along bending lines of the other shaping die. In this case, the elevations and depressions are always adjacent to one another or are in each case formed by two bending lines extending adjacent to one another. By increasingly pressing the shaping dies together or engaging the shaping dies in one another, the holding dies with the flat web material therebetween are deformed or raised in a corresponding shape, wherein elevations and depressions are obtained or formed along the bending lines and thus also along the kink lines of the holding dies. The folding lines of the flat web material are thus obtained along the bending lines and kink lines, or the flat web material is folded here. Since the holding dies are as it were sharply kinked or folded along the kink lines, precisely defined and sharply folded folding lines are produced in the flat web material by the corresponding sharp edges or ridges of the holding dies.

As explained above, the pressing together of the shaping dies toward one another with the compound structure of holding dies and flat web material therebetween takes place gradually or becomes progressively greater. Here, the dies are in each case advantageously elongate. As a particularly preferred option, the shaping dies can be pressed together along a path or throughput path in a continuous process. In this case, a plurality of pressure means or deformation means, which are preferably of circulating design, arranged in series along the path, can be provided. The pressure means can be rotating rolls, round brushes or, alternatively, pressure means circulating in the manner of belts or deformation belts. A pass height between pressure means arranged in succession in the throughput direction can decrease, in particular by in each case up to 15% of the pass height per pressure means or belt. By means of the pressure means, it is possible for the shaping dies to engage in one another or to be pressed into one another, wherein they bring about the deformation of the holding dies and the raising thereof and the deformation and raising of the flat web material. In this case, the shaping dies can engage in one another by 25% to 50% or even by up to 75% of the height thereof, for example, with the result that the total height of the arrangement comprising the shaping dies, holding dies and flat web material is between 175% and 125% or even just 110% of the height of a single shaping die.

While the holding dies, together with the material thereof, are chosen and designed in such a way that relatively easy deformability is obtained along the kink lines but the regions between are quite dimensionally stable, precisely for a defined deformability at the kink lines, the shaping dies can be relatively stiff or stable, including along the bending lines provided there, especially if they are resting on the holding dies. In particular, provision can be made, as regards the shaping dies, for the shape of said dies to change only relatively little, especially along the bending lines, during the shaping of the flat web material, preferably by 2% to 15% in the height thereof. To achieve this, they can be produced from a considerably stiffer material than the holding dies, particularly in virtue of a greater material thickness, even if it is per se the same material.

As an advantageous development of the invention, a vibration device is provided, or the arrangement is vibrated, more precisely after the shaping dies have been moved up to the holding dies until there is contact. Moreover, this should take place before the substantial deformation of the holding dies, that is to say, for example, before these have reached 10% or 20% of their desired height of the finished structure of the flat web material.

As another advantageous development of the invention, it is possible for the holding dies and/or the shaping dies not just to be formed anywhere on a surface, e.g. in the manner of pressure plates or the like, but to be formed as long belts. It is advantageous if these are circulating belts, that is to say as it were endless belts. The length of these belts should be more than twice the length of the throughput path for the flat web material for the deformation thereof, thus allowing them to run around with a sufficiently large radius at the start and end of this throughput path without being damaged in the process. Depending on the design of the dies, there may also be a substantial shortening, especially of the holding dies, e.g. by up to a factor of 2 to 10. A corresponding length must be allowed for here.

The advantage of such dies in the form of belts or even circulating belts is that longer pieces of the flat web material can be shaped and, in the case of circulating belts, even in principle continuous flat web material. Moreover, a continuous in-line process can be carried out for high throughput and an optimum result in the regular three-dimensional structure that has been produced from the flat web material. In this case, the belts of the holding dies can directly adjoin the throughput path at the top and bottom, with the belts of the shaping dies in each case on the outside thereof but running around on the inside. In the case of circulating closed endless belts for one of the dies or both dies, the belts of the holding dies can run around the belts of the shaping dies or they can surround them.

Synchronization, at least of the holding dies with one another and with the flat web material fed in, should advantageously take place. This is to be preferred especially when a preembossed flat web material is used or one in which the folding lines are predetermined in a precisely defined way by weakened points in the material, e.g. perforations or the like. On the one hand, synchronization can be achieved purely by control of the drive motors. An advantageous possibility is the use of mechanical synchronization means, e.g. rolls with elevations in the form of spikes or prongs or even synchronization belts. Moreover, location holes, like those for paper feed in dot matrix printers, into which corresponding projections on the holding dies engage, could be provided in the flat web material.

As a further development of the invention, it is possible, in the case where the method is carried out as a continuous process, for synchronization between the upper shaping die and the lower shaping die to be performed directly after the shaping dies have been moved up to the holding dies and placed in contact. This can also be regarded as it were as a continuation of the abovementioned synchronization of the holding dies with one another and optionally with the flat web material. For this purpose, it is likewise possible for abovementioned synchronization means to be provided, advantageously by way of control motors or by way of rotating synchronization means or synchronization belts with external shaping corresponding to the structure or shape of the shaping die. By means of such synchronization, it is possible to ensure that the kink lines of the holding dies lie precisely one above the other and bring about neat folding of the flat web material and that, as envisaged, the shaping dies engage between these kink lines by means of the elevations and, between them, deform or profile the compound structure of the holding dies with the flat web material.

In general, provision can be made for synchronization to synchronize both die pairs and also the flat web material at the same time but, as an alternative, individual synchronization can also be performed. This can also mean that not even the dies of one pair are synchronized at the same time. Thus, the method can be carried out very simply without major expenditure on plant.

As a development of the invention, it is possible for lateral pressing means to be provided on the side, in the case of a continuous process preferably on the longitudinal sides, of a throughput path for the flat web material, said pressing means pressing together the holding dies laterally with the flat web material between them and/or pressing together the shaping dies laterally with the holding dies and the flat web material between them. As the flat web material is folded or folded up, it is both shortened in length and reduced in width when the flat web material before deformation and the finished structure after deformation are compared. This is obvious since the material enters into the three-dimensional structure. Through lateral compression, it is possible to provide additional support for the deformation of the flat web material or folding. Above all, such lateral pressing means can be of relatively simple construction in comparison with pressing means on the top side or bottom side since they do not need to have a shape corresponding to the raised shape. They can simply be oblique belts or rollers or wheels, which are arranged so as to move closer together, and guides, preferably guide plates or rails.

After the deformation of the flat web material into the desired three-dimensional structure, this being by at least 30% up to 60% or more, the shaping dies are initially moved away. An even greater deformation can then take place, in particular at this stage between the holding dies. After this or later, the holding dies are then also moved away or taken off. This can then be performed in an abovementioned continuous process by just a few centimeters, e.g. 5 cm to 50 cm. However, separate release is a better way of allowing for the fact that the shaping dies are stiffer and thus behave somewhat differently than the holding dies.

The three-dimensional structure produced in the flat web material is distinguished by the fact that it has elevations and depressions along folding lines, which are, as it were, sharply folded and form sharp angles, advantageously with an angle between 10° and 150° on both sides of the fold, particularly advantageously between 20° and 120°. Before the shaping dies are moved away from the holding dies, the bending lines extend along elevations on the shaping dies, along kink lines on the holding dies and folding lines of the flat web material. Ultimately, the bending lines along elevations are the only regions which protrude from the shaping dies and rest on the holding dies. This applies only to the projection into the plane of symmetry: the kink lines on shaping dies on one side and on holding dies or on the flat web material on the other side do not all touch.

As a further development of the invention, it is even possible, after the shaping dies have been moved away from the holding dies, to carry out yet another or even more pronounced deformation of the flat web material, particularly if it is still between the holding dies. In this case, engaging conveying means can be provided, which convey the compound structure comprising the holding dies and the flat web material not only in the throughput direction along a throughput path, advantageously by means of positive engagement, but also compress it in the throughput direction. In this arrangement, said conveying means can be circulating and can have an external structure or shape which can enter the finished shape of the flat web material as a three-dimensional structure in the final state. A compression as mentioned above can additionally also take place in the transverse direction here. Because the shaping dies, which are more difficult to deform transversely and/or longitudinally, have already been moved away at this point in time, this deformation between them of the compound structure comprising the holding dies and the flat web material can take place more easily and with less force.

In yet another advantageous development of the invention, provision can be made for folding lines to be produced in the flat web material only in two or three directions. These two or three directions should then be at an angle of between 60° and 120° to one another, wherein above all angles that are too sharp, in particular less than 45°, should if possible be avoided. In this way, a simultaneously stable and advantageous three-dimensional structure consisting of a flat web material can be produced easily. In the side view, the angle can be 20° to 90° and, in the plan view, it can be 10° to 150°.

Provision is advantageously made for the flat web material to be single-ply, at least in the final state as a three-dimensional structure. It is possible here to introduce several plies of a flat web material, especially if it is thin and easily foldable like paper, e.g. two to four such plies one on top of the other, between the holding dies and then to convert it, as described above, by means of the shaping dies into a three-dimensional structure with multi-ply superposition. The individual plies can then be separated from one another, thus allowing two to four structured strips, for example, to be produced with a single shaping step. After an at least substantial pre-shaping step, these can then be deformed further using the abovementioned means, in particular by compression in the longitudinal direction and/or transversely, which is then easily possible by virtue of the predetermined folding lines. In this way, overall throughput can be increased.

As an alternative, a flat web material can be of multi-ply construction, for higher material stiffness or in order to combine certain functional layers with one another, for example. There is a large number of possibilities available here.

Moreover, paper or a similar material composed of fibers can be used as a material for the flat web material. Homogeneous films made of plastic, as well as metal foils, can likewise be used. The thickness should be chosen so that the flat web material can be folded easily, i.e. conventional paper weights or thicknesses and, in the case of metal foils, thicknesses of less than 0.2 mm.

These and further features are apparent not only from the claims but also from the description and the drawings, wherein the individual features can each be implemented individually or jointly in the form of subcombinations in an embodiment of the invention and in other sectors and can represent embodiments which are advantageous and inherently capable of being protected, for which protection is claimed here. The subdivision of the application into individual sections and subheadings does not restrict the general applicability of the statements made within and between them.

### BRIEF DESCRIPTION OF THE DRAWINGS

Illustrative embodiments of the invention are shown schematically in the drawings and are explained in greater detail below. In the drawings:

FIG. 1 shows a schematic side view of a device for shaping a flat web material,

FIG. 2 shows a first embodiment of shaping belts in the form of double conveyor belts with a constant spacing relative to one another,

FIG. 3 shows a modification of the deformation belts in the form of double conveyor belts from FIG. 2 with a decreasing spacing relative to one another in the throughput direction,

FIGS. 4 to 6 show an illustration in three stages of the shaping of the flat web material between the upper and lower holding dies, which are deformed by upper and lower shaping dies in order to shape the flat web material to raise it into a three-dimensional structure,

FIGS. 7 to 13 show various final patterns or final shapes of a shaped flat web material in isometric view, plan view and side view and as a unit cell of a plane folding pattern.

### DETAILED DESCRIPTION OF THE ILLUSTRATIVE EMBODIMENTS

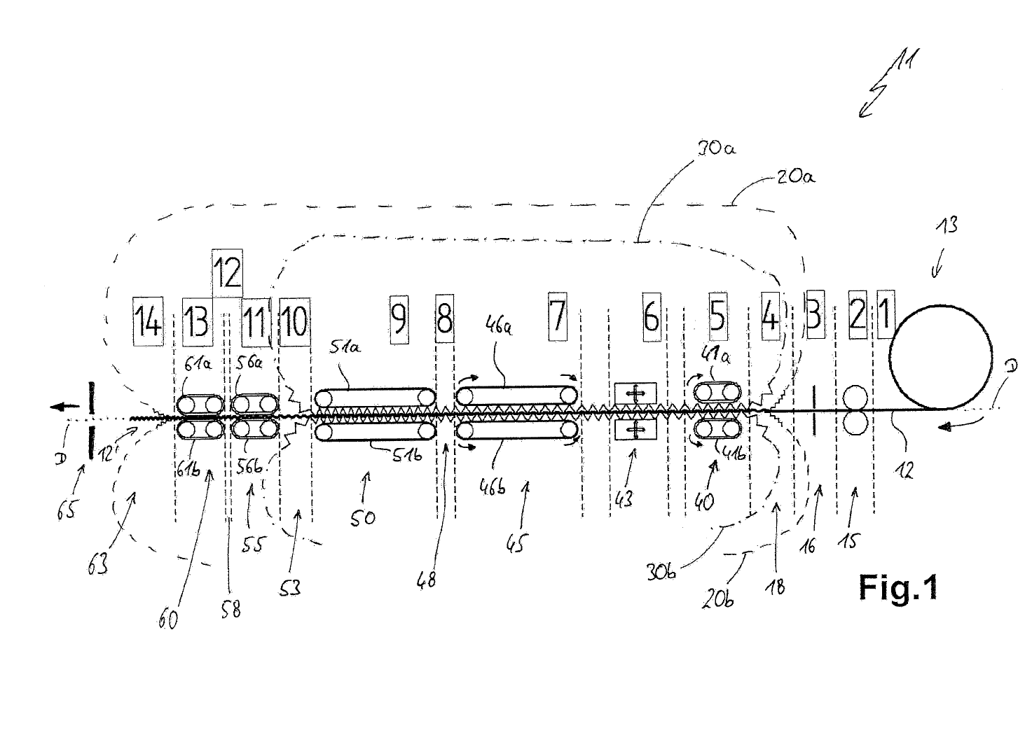

FIG. 1 shows a device 11 according to the invention for shaping a flat web material 12, which comes from a material supply 13 in the form of a large roll or the like. In FIG. 1, the flat web material 12 runs from right to left through throughput plane D, which is illustrated by a dotted line on the left and right. The flat web material 12 can be one of those mentioned above, e.g. paper, but can also be thin plastic in the form of film material or thin web material, and can likewise comprise metallic materials such as thin aluminum foil and composite materials. As mentioned at the outset, it can even be slightly corrugated with corrugations of between 0.5 mm and 3 mm. After being unwound from the material supply 13, the flat web material 12 passes through an optionally provided embossing device 15. This can already preemboss the folding lines for subsequent folding or shaping, thus allowing this shaping to be carried out more easily. For this purpose, appropriately known embossing rolls with narrow ridge-type elevations can be used. However, the material can also arrive already preembossed or on a roll.

There then follows an optionally provided cutting device 16, which carries out a cross cut. In this way, the virtually continuous strip of flat web material 12 can be divided into particular or desired lengths. As an alternative, the flat web material 12 can also be fed in the form of individual sheets. In addition to the cutting device 16 for a cross cut, it is also possible to provide one or two longitudinal cutting devices to cut the flat web material 12 to an appropriate width as well.

As the next stage, the flat web material 12 passes through a feed region 18. In this region, an upper holding die 20a and a lower holding die 20b are first of all fed in simultaneously or, alternatively, in succession, from above and below, symmetrically with respect to the throughput plane D. These holding dies 20 circulate in large loops largely depicted in dashed lines and are designed as abovementioned continuous belts. For this purpose, they are composed of an appropriately stable plastics material. Combinations of different materials, e.g. metal and plastic, or simply metal with hinges or the like are also conceivable. The holding dies 20a and 20b can be moved up in a flat or smoothed form to the flat web material 12. For this purpose, corresponding smoothing devices, advantageously rolls pressed against one another, can be provided between the extreme left-hand end of the device 11 and the feed region 18. At any event, the holding dies 20a and 20b should come to rest to a large extent flat or over an extended area on the flat web material 12 in the feed region 18. At the same time, this material may already be shaped somewhat out of the flat form.

Shortly after the holding dies 20a and 20b, the upper shaping die 30a and the lower shaping die 30b are moved up in the feed region 18 in the embodiment of the device shown here. These dies too are continuous belts circulating in the manner of loops with a course which is illustrated largely by dotted lines. In this case, corresponding guiding devices or guide rollers (not shown here) are provided. Unlike the holding dies 20a and 20b, the shaping dies 30a and 30b are not moved up in a largely flat form but, as illustrated, in raised form, that is to say their shape advantageously changes only slightly, e.g. by the 2% to 15% mentioned above. As illustrated in the enlarged form below, the shaping dies 30a and 30b rest by means of their mutually facing points or protruding regions against the outsides of the holding dies 20a and 20b.

The compound structure comprising the flat web material 12, the holding dies 20a and 20b resting on the latter, and the shaping dies 30a and 30b in turn resting on said holding dies moves to the left in a continuous process and is guided into an optionally provided synchronization device. As described above, it is also possible for the dies and the flat web material to be synchronized in succession in the synchronization. This can mean that synchronization coincides with the feed region 18, and the dies with the flat material are synchronized in pairs or, alternatively, in succession before a further die or a further die pair is moved up. Additional synchronization is important or advantageous especially for the holding dies with the material to ensure that the optional stamped lines coincide with the folding lines of the dies. Synchronization can also be performed by means of rolls, vibrators or the like. The design shown here of the synchronization device has an upper synchronization belt 41a and a lower synchronization belt 41b, which serve to synchronize the dies with one another or bring them into the correspondingly desired position relative to one another and optionally relative to the flat web material, especially the upper and lower shaping dies 30a and 30b. For this purpose, the synchronization belts 41a and 41b can have protruding elevations or spikes which engage in the outsides of the shaping dies 30a and 30b with such precision of location or accuracy of position that they can be positioned as desired relative to one another.

The synchronization device 40 is followed by a vibration device 43, which is likewise provided only as an option. This can comprise pressure jaws or the like, which are flexible, for example, and which not only compress the compound structure further but also position the dies 20a, 20b and 30a, 30b relative to one another longitudinally and/or transversely with respect to the throughput direction. In particular, as a result, slight deformation of the holding dies 20a and 20b with the flat web material 12 between them in accordance with kink lines of the holding dies can possibly already take place or start.

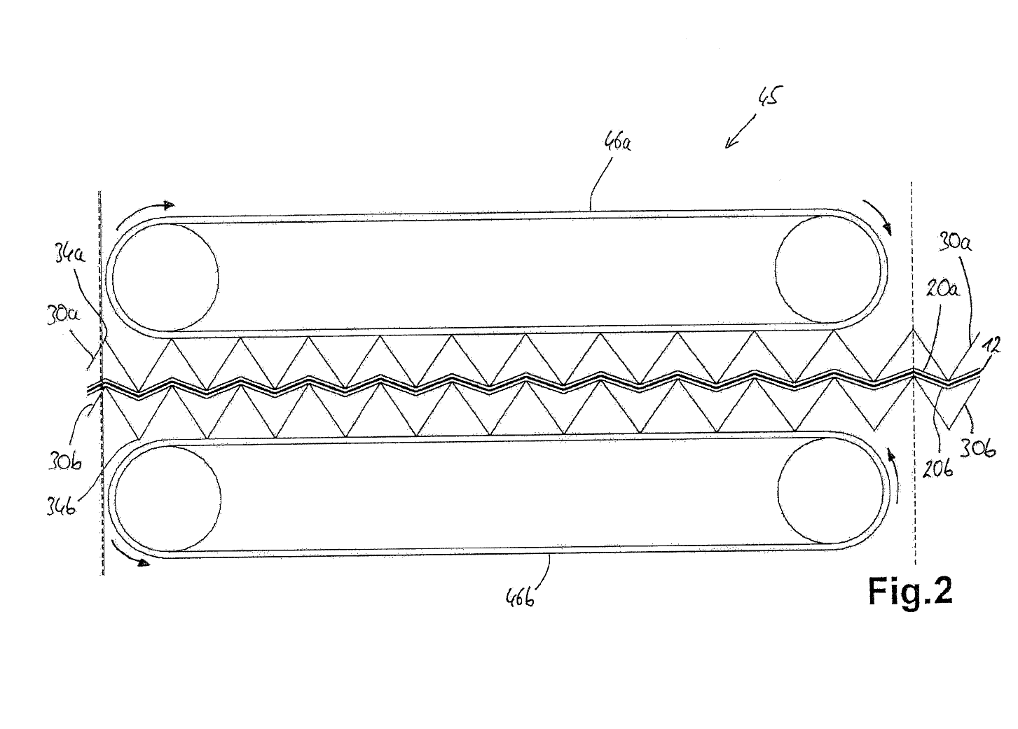

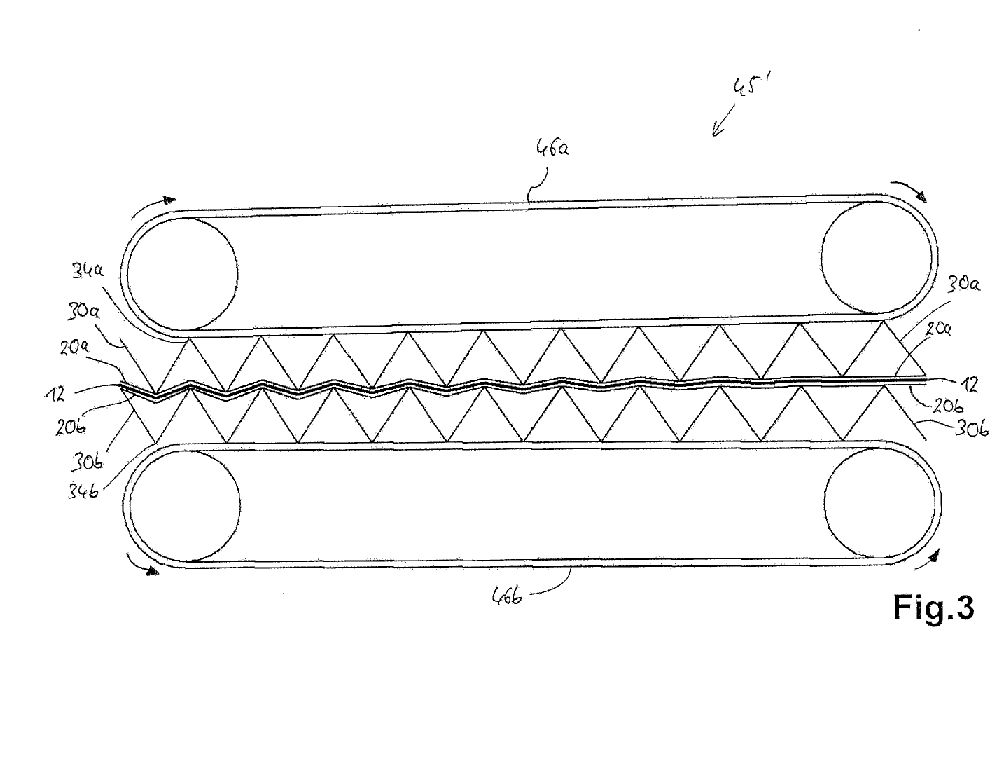

An upper first deformation belt 46a and a lower first deformation belt 46b circulate in a subsequent first deformation region 45, as is also illustrated on an enlarged scale in FIGS. 2 and 3. The deformation belts 46a and 46b are largely flat and push the shaping dies 30a and 30b toward one another, as illustrated on an enlarged scale there. They correspond to the pressure means mentioned at the outset.

The first deformation region 45 is followed by what is referred to as a first contraction region 48, which, although optional, should advantageously be provided. In this region, the compound structure is as it were braked between the first deformation region 45 and a subsequent second deformation region 50 and is thereby compressed or shortened. At the same time, as is apparent from the following illustrations, this causes more pronounced deformation of the flat web material and of the holding dies 20a and 20b by more pronounced raising or shaping out of the throughput plane D.

After this, the compound structure passes through a second deformation region 50, in which, as in the first deformation region 45, an upper second deformation belt 51a and a lower second deformation belt 51b are provided. These can be of identical design to the deformation belts 46a and 46b in the first deformation region 45 but, as an alternative, they can also be designed in accordance with the other of the two basic possibilities in FIGS. 2 and 3. As can be seen from FIG. 1, the dies 20a, 20b and 30a and 30b, together with the flat web material 12 between them, are raised to a greater extent in the second deformation region 50 and thus deformed to a greater extent. The spacing between the second deformation belts 51a and 51b should also be somewhat less than that between the first deformation belts 46a and 46b.

As one possibility, it is then possible for yet further deformation regions having further deformation belts that are even less far apart to follow. As an alternative, a first lifting region 53 can follow, in which the shaping dies 30a and 30b are lifted off and can thus be moved away from the holding dies 20a and 20b by being guided away in each case, wherein abovementioned deflection rollers or the like can be provided here.

In a subsequent third deformation region 55, upper and lower third deformation belts 56a and 56b are once again provided, said belts holding and conveying and, in the process, deforming the holding dies 20a and 20b with the flat web material 12 therebetween between them under pressure. After the third deformation region 55 there follows a fourth deformation region 60 with an upper fourth deformation belt 61a and a lower fourth deformation belt 61b. Technically, it is conceivable that regions 55 and 60 are deformation regions but the principle purpose is to ensure the speed difference by conveying the dies and the flat material at different speeds so that the contraction region 58 works. Between them, a second contraction region 58 can be provided, in which the compound structure passing through is braked even further and is thus shortened and raised or deformed to a greater extent. The region between 50 and 55, i.e. region 53, can additionally also be a contraction region. The deformation belts 56a, 56b and 61a, 61b can be largely level on the upper side thereof, with a rubberized or highly slip proof surface, in order to grip the holding dies 20a and 20b, situated in each case on the outside, with good nonpositive engagement and to convey them. As an alternative, elevations and/or depressions can be provided for conveyance by positive engagement. Whereas the pressure from outside on the compound structure was important in deformation regions 45 and 50 because it has brought about relatively pronounced deformation of the holding dies 20a and 20b with the flat web material 12 between them, the pressure in deformation regions 55 and 60 should not be too great since it otherwise once again compresses the holding dies 20a and 20b with the flat web material 12 between them. Further deformation regions or contraction stages can follow, even after the lifting off of the holding dies.

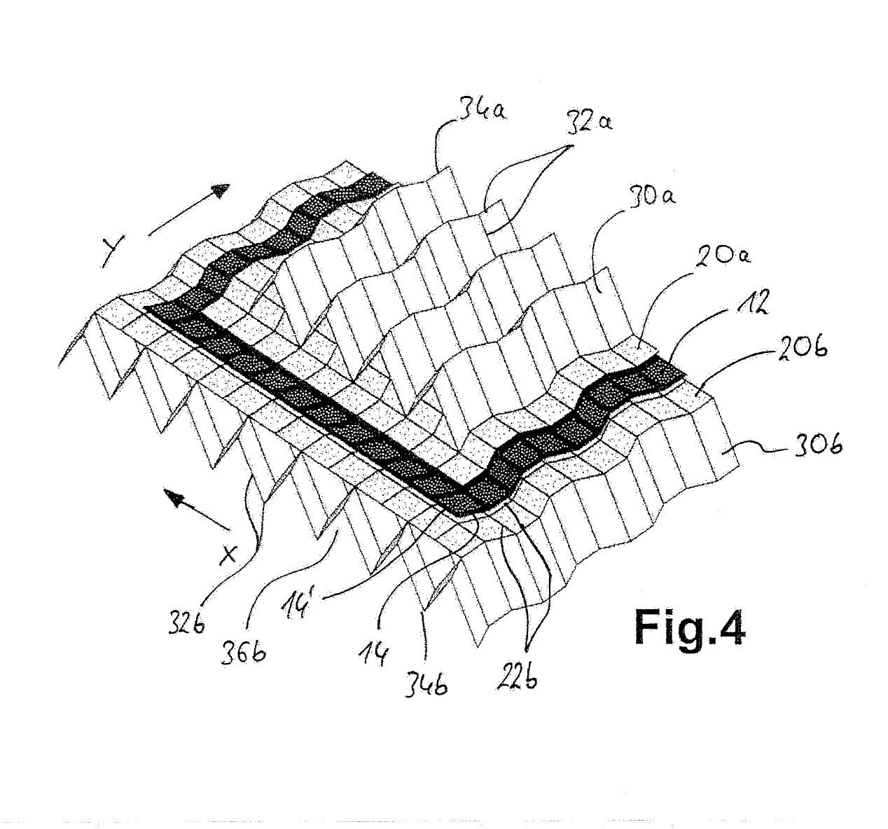

In a second liftoff region 63, the holding dies 20a and 20b are then lifted off or moved away from the flat web material 12. Here, the flat web material 12 can then have its final structure or shape, as can be seen on the extreme left in FIG. 1, and in which respect reference is also made to FIGS. 4 to 13. A cutting device 65 can then possibly also be provided, especially if none is provided at the start. Otherwise, the shaped flat web material 12′ can be conveyed onward for a use as mentioned at the outset, especially for a component of sandwich construction. In some circumstances, however, a further deformation of the flat web material 12 can generally be performed even after liftoff of the holding dies, e.g. by its being compressed longitudinally and pressed transversely for example. As a further possibility, a hardening region, a tempering region or the like can follow.

A first possible embodiment of the first deformation region 45 with an upper first deformation belt 46a and a lower first deformation belt 46b is shown on an enlarged scale in FIG. 2. The first deformation belts 46a and 46b have a constant spacing with respect to one another over their length and thus press on the outer ridges 34a and 34b of the upper shaping die 30a and lower shaping die 30b respectively. This has the effect that the compound structure comprising the flat web material 12 and the holding dies 20a and 20b coming from the right are pressed together even more strongly, specifically right at the start as they run into the first deformation region 45 or between the first deformation belts 46a and 46b and also into the second deformation region 50 with belts 51a and 51b. In the next deformation region with its deformation belts as shown in FIG. 1, the spacing between the upper and lower deformation belt can then, in turn, be somewhat less than illustrated here.

In the alternative second possible embodiment of a first deformation region 45′ shown in FIG. 3, the mutually facing sides of the upper first deformation belt 46a and of the lower first deformation belt 46b do not run parallel to one another but are oblique relative to one another, or the spacing thereof decreases somewhat in the throughput direction from right to left, advantageously by 1% to 5% or even 15%. The clear pass height simply becomes smaller. Here too, the ridges 34a and 34b of the shaping dies 30a and 30b rest against the first deformation belts 46a and 46b. However, it can be seen very clearly how, on the right, the compound structure comprising the flat web material 12 and the holding dies 20a and 20b is still flat and level but, as it progresses increasingly through the first deformation region 45′, is deformed because the shaping dies 30a and 30b engage in one another to a greater extent owing to the decreasing clear height and, in the process, deform said compound structure.

Here too, it is possible for the subsequent deformation region to be designed in the same way as the first deformation region 45′ illustrated here in FIG. 3, i.e. for uniform deformation beginning virtually at zero. The combination of the deformation regions as shown in FIGS. 2 and 3 has not been depicted explicitly but is likewise conceivable.

In FIGS. 4 to 6, the intention is to illustrate, in three steps, how the deformation, ultimately of the flat web material 12 but also of the holding dies 20a and 20b, by the shaping dies 30a and 30b becomes more and more pronounced. In FIG. 4, no significant deformation of the flat web material 12 and of the holding dies 20a and 20b resting against said material is yet visible in the x direction, which is transverse to the throughput direction through the device 11. In the y direction in the throughput direction, however, an initial deformation is already clearly visible, so that the compound structure comprising the flat web material 12 and the holding dies 20a and 20b is slightly corrugated in this direction. In general, it is the case that a deformation in the y direction is always associated with a deformation in the x direction, but there may be significant differences of degree between them. As regards alignment, it is also conceivable that the x direction is along the throughput direction. For the sake of clarity, folding lines 14 and 14′ of the flat web material 12 are already shown here, as are kink lines 22a and 22b of the holding dies 20a and 20b. The shaping dies 30a and 30b have ridges 34a and 34b projecting in opposite directions with correspondingly mutually facing depressions 36a and 36b. These are each formed by bending lines 32a and 32b. The depressions 36a and 36b in particular press by means of their relatively sharp edges corresponding to the ridges 34a and 34b into the compound structure comprising the flat web material 12 and the holding dies 20a and 20b. It can be seen here how the depressions 36a and 36b extend precisely along corresponding kink lines 22a and 22b of the holding dies 20.

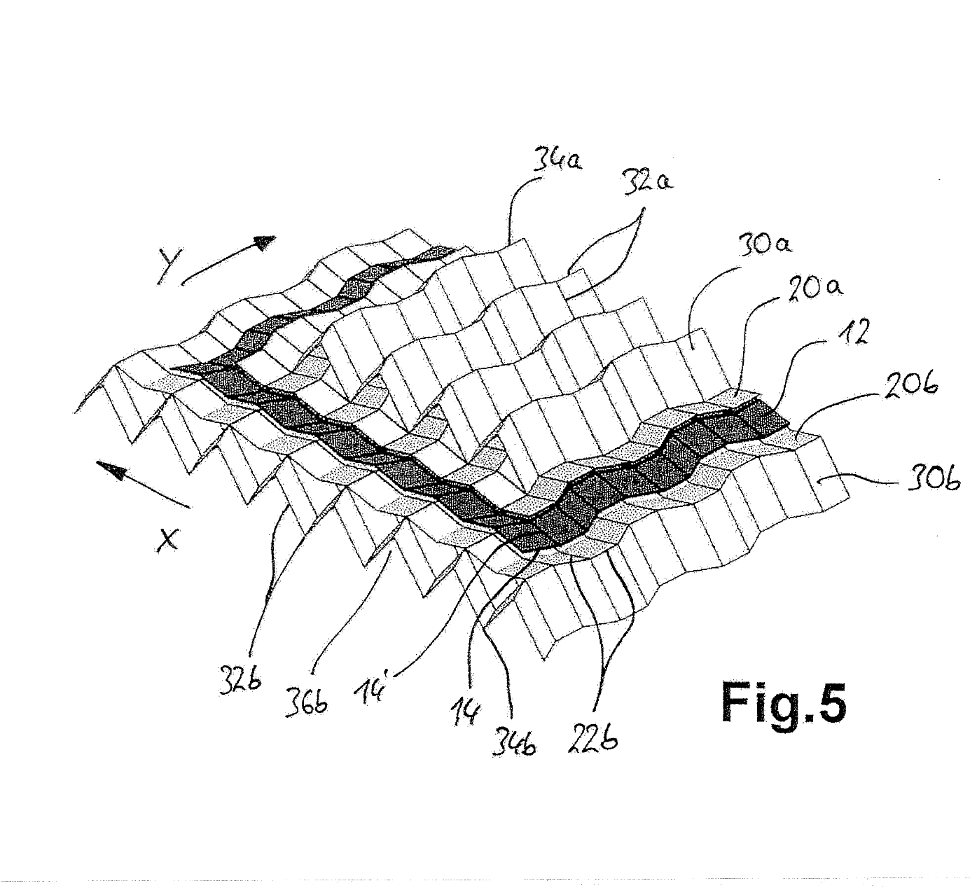

More pronounced deformation of the flat web material 12 together with the holding dies 20a and 20b occurs in FIG. 5 through their being pressed together more, this now also being clearly visible in the x direction along the folding lines 14 and 14′ of the flat web material 12 and along corresponding kink lines 22 of the holding dies 20a and 20b. In this case, the shaping dies 30a and 30b are still in contact with the depressions 36a and 36b linearly only along kink lines 22a and 22b of the holding dies 20a and 20b.

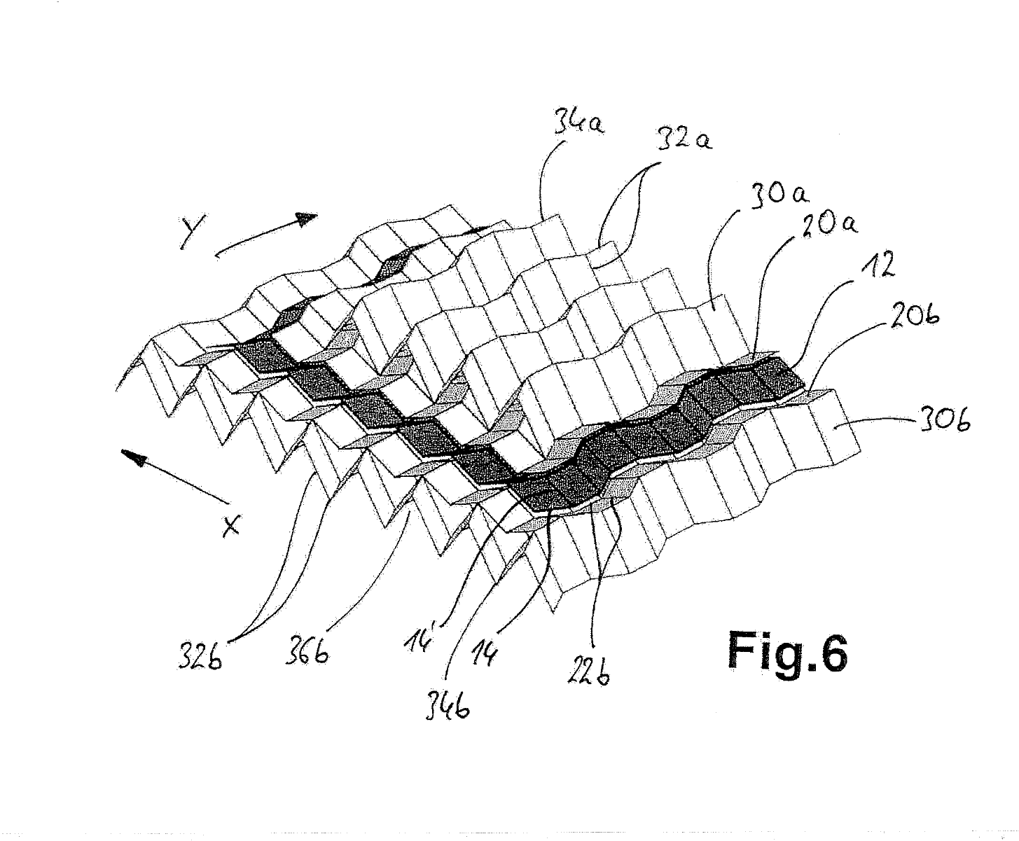

Even greater deformation is shown in FIG. 6. Here too, it should be noted that the compound structure comprising the flat web material 12 and the holding dies 20a and 20b has been deformed with the same intensity and to the same extent but the shaping dies 30a and 30b themselves have hardly been deformed at all. In this state, it would be possible in some circumstances for liftoff of the shaping dies 30a and 30b to take place already as in the first liftoff region 53 in FIG. 1. As an alternative, however, even greater deformation can take place. In the abovementioned case, the compound structure comprising the flat web material 12 and the holding dies 20a and 20b can only be deformed further through further shortening and also compression with the deformed flat web material 12′ being raised in a more pronounced way.

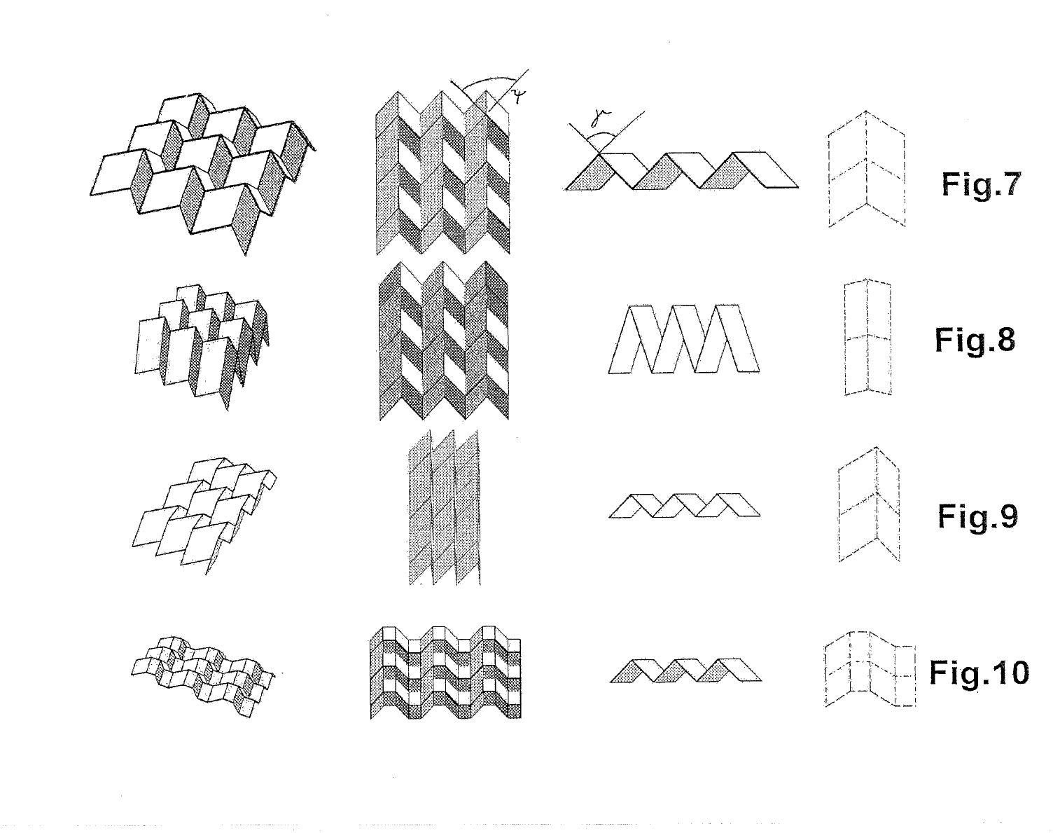

Various possible embodiments of the shaped flat web material 12′ are shown in FIGS. 7 to 13. On the extreme left, an isometric view is shown in each case, then a plan view from above, then a partial side view and, finally, on the extreme right, a plane folding pattern of, as it were, an individual cell. The embodiments in FIGS. 7 to 9 are characterized essentially by zigzag patterns of the folding lines 14, which in each case form ridges and depressions. There are therefore folding lines in two directions with angles of about 90° to one another in FIGS. 7 and 8 and 45° to 60° in FIG. 9. In FIGS. 10 and 11, these are patterns with a plurality of kinks along ridges and depressions at the folding lines 14, namely with a total of three instead of two directions. The angles are respectively about 135° in FIG. 10 and about 90° and 135° in FIG. 11. In FIG. 7 the angle φ is about 45° to 120° and the angle γ is about 15° to 90°.

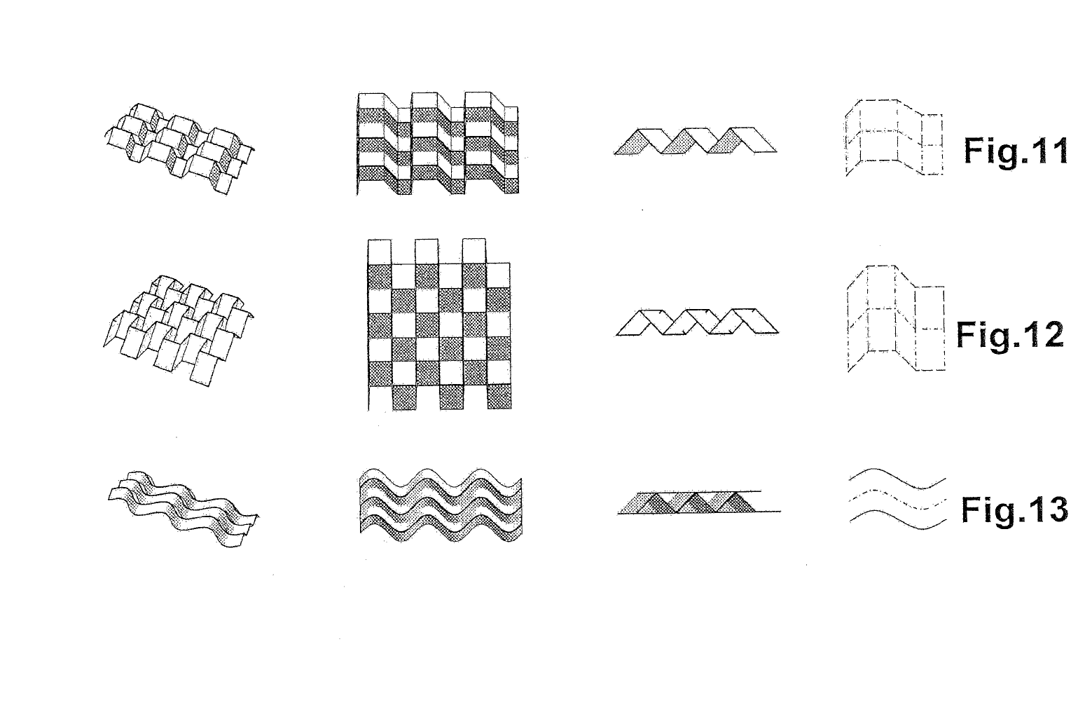

In FIG. 12, there are once again just two directions but these correspond instead to an embodiment corresponding to FIG. 10 with in each case a right angle at the individual kinks of the folding lines of the ridges and depressions.

In the embodiment according to FIG. 13, there is a special feature inasmuch as, here, the folding lines and thus also the ridges and depressions are not straight sections or segments but are curved or have a continuous corrugated profile, as mentioned at the outset. Here, the production of kink lines 22 in the holding dies 20 and bending lines 32 in the shaping dies 30 can be somewhat more involved but, in principle, this is also possible and conceivable.

1. A method for shaping a flat web material, wherein said flat web material is largely flat or smooth and level in an initial state and, when folded in a final state, is in a periodic three-dimensional structure, said periodic three-dimensional structure having a multiplicity of folds along differently oriented folding lines and having elevations and depressions, said method having the following steps:
said flat web material is inserted between a lower holding die and an upper holding die, wherein said holding dies are composed of flat material and have preformed kink lines, said kink lines being identical on said two holding dies and lie precisely one above the other when they are resting on said flat web material,
moving a lower shaping die and an upper shaping die up to said holding dies from below and from above respectively, wherein said shaping dies are composed of flat material with predetermined bending lines,
said holding dies are largely level during an insertion of said flat web material and also as said shaping dies are moved up,
said shaping dies have bending lines precisely corresponding to one another or precisely lying opposite one another, with identical bendings along said bending lines, wherein said shaping dies are not flat but are raised by bending along said bending lines or have a shape corresponding to said three-dimensional structure to be produced with said flat web material, wherein at least some of said bending lines of said shaping dies coincide with some of said kink lines of said holding dies.

2. The method as claimed in claim 1, wherein, as said method progresses, said shaping dies largely retain their shape and/or said holding dies are deformed and are raised in a corresponding shape with elevations and depressions along said kink lines of said holding dies.

3. The method as claimed in claim 1, wherein, as said shaping dies are moved up to said holding dies, a plane situated in a middle between said shaping dies is not yet touched by said shaping dies, wherein, as said method progresses, said shaping dies are moved ever further toward one another or elevations along bending lines of one said shaping die engage in depressions along bending lines of said other shaping die, wherein said holding dies with said flat web material therebetween are deformed or raised in a corresponding shape with elevations and depressions along said bending lines and thus along said kink lines of said holding dies as said shaping dies are increasingly pressed together or as they increasingly move one into another, as a result of which said folding lines of said flat web material are obtained along said bending lines and said kink lines.

4. The method as claimed in claim 1, wherein pressing together of said shaping dies takes place along a throughput path in a continuous process by means of a plurality of circulating pressure means arranged in series.

5. The method as claimed in claim 1, wherein, in a case where said method is carried out as a continuous process, said holding dies are synchronized with said flat web material, before said shaping dies are moved up.

6. The method as claimed in claim 1, wherein, in that a case where said method is carried out as a continuous process, synchronization between said upper shaping die and said lower shaping die is performed directly after said shaping dies have been moved up to said holding dies and placed in contact, preferably by means of rotating or circulating synchronization means with an external shape corresponding to said structure or said shape of said shaping die.

7. The method as claimed in claim 1, wherein, in a state just before said shaping dies are moved away from said holding dies, bending lines extend along elevations on said shaping dies along all said kink lines of said holding dies and all said folding lines of said flat web material.

8. The method as claimed in claim 1, wherein, after said shaping dies have been moved away from said holding dies, a further or even more pronounced deformation of said flat web material takes place between said holding dies by means of positively engaged conveyance, by means of engaging conveying means, of said compound structure comprising said holding dies and said flat web material, with compression in a throughput direction or with a shortening in length.

9. The method as claimed in claim 1, wherein said folding lines of said flat web material extend only precisely in two or three directions, wherein said directions are preferably at an angle of between 60° and 120° to one another.

10. The method as claimed in claim 1, wherein said flat web material is single-ply or not folded upon itself in said initial state and in said final state.

11. A device for carrying out said method as claimed in claim 1, wherein said device has a throughput path along which said flat web material to be shaped passes, wherein a holding die, and above it a shaping die, are arranged from above on said throughput path, and wherein a holding die and below it a shaping die are arranged on said throughput path from below, wherein said holding dies are composed of flat material and have pre-formed kink lines being are identical on said two holding dies and lie precisely one above another when resting on said flat web material, and wherein said shaping dies are composed of flat material and have preformed bending lines corresponding precisely to one another or lie precisely opposite one another, with identical bending along said bending lines, wherein said shaping dies are raised by bending along said bending lines or have a shape corresponding to said three-dimensional structure to be produced with said flat web material, wherein at least some of said bending lines of said shaping dies coincide with kink lines of said holding dies.

12. The device as claimed in claim 11, wherein at least one deformation region with pressure means for deformation, is provided along said throughput path.

13. The device as claimed in claim 11 wherein, after said shaping dies have been moved up into contact with said holding dies and before a substantial deformation of said holding dies, a vibration device is provided or vibrates said arrangement somewhat.

14. The device as claimed in claim 11, wherein said holding dies and/or said shaping dies are circulating belts with a length of more than twice said throughput path for said flat web material, which is a long web or a continuous web, wherein said belts of said holding die each run around or surround said belts of said shaping die.

15. The device as claimed in claim 11, wherein lateral pressing means are provided on the side of said throughput path for pressing together said holding dies laterally with said flat web material between them and/or pressing together said shaping dies laterally with said holding dies and said flat web material between them.

16. The method as claimed in claim 4, wherein said pressure means are pressure means circulating in a manner of belts.

17. The method as claimed in claim 4, wherein a pass height between said successive pressure means in said throughput direction decreases or becomes smaller.

18. The method as claimed in claim 8, wherein said conveying means are circulating conveying means and have an external structure or shape corresponding to a finished shape of said flat web material in a final state.
